(19) United States
(12) Patent Application Publication
(10) Pub. No.: US 2012/0114111 A1
(43) Pub. Date: May 10, 2012

(54) TELECONFERENCE DEVICE

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/095,892

(22) Filed: Apr. 28, 2011

(30) Foreign Application Priority Data
Nov. 5, 2010 (TW) 99138190

(51) Int. Cl. H04M 3/42

(52) U.S. Cl. 379/202.01

(57) ABSTRACT

A teleconference device includes a microphone, a support member, and a loudspeaker. The loudspeaker includes a hollow casing, a speaker arranged within the hollow casing and on a bottom thereof; and a hard plate arranged under the speaker and abutting against the support member. The hollow casing is heavier than the hard plate to cause the hard plate to stay in tight contact with the support member, to allow sound outputted by the loudspeaker through the support member.

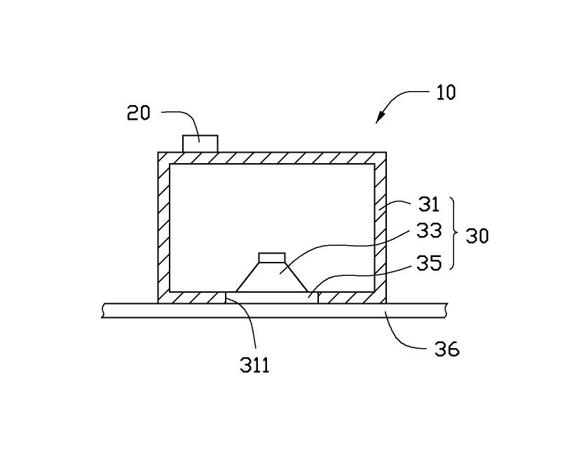

### BACKGROUND

1. Technical Field

The present disclosure relates to a teleconference device.

2. Description of Related Arts

Teleconferencing has long been an essential tool for communication in business, government, and educational institutions. It is common in a conference call in which a speaker system is being used that voices amplified by the speakers are not clear and crisp, thus making the communication difficult.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The figure is a schematic, cross-sectional view of a teleconference device according to an exemplary embodiment.

### DETAILED DESCRIPTION

Embodiments of the present disclosure will now be described in detail below, with reference to the accompanying drawings.

Referring to the drawing, a teleconference device 10 includes a microphone 20 and a loudspeaker 30. The loudspeaker 30 includes a casing 31, a speaker 33, a hard plate 35, and a support member 36. The microphone 20 is set on top of the loudspeaker 30 for receiving acoustic signals transmitted via the air.

The casing 31 is hollow and defines a through hole 311. The hard plate 35 has substantially the same size as the through hole 311, and is fit into the through hole 311. The hard plate 35 can move with respect to the through hole 311. The bottom of the hard plate 35 is flush with the lower surface of the bottom of the casing 31. When the casing 31 is placed on a support member 36, the bottom of the casing 31 and the hard plate 35 contact the top of the support member 36. In the embodiment, the hard plate 35 can be made of plastic.

The speaker 33 is arranged on the hard plate 35. The casing 31 is much heavier than the hard plate 35. The hard plate 35 can then stay in substantial surface-to-surface contact with the top of the support member. In the embodiment, the casing 31 may be made of metal.

The support member 36 is a thin membrane made of material such as a vinyl sheet. When the hard plate 35 vibrates together with a voice coil of the speaker 33, the thin film 36 vibrates together with the hard plate 35. That is, the support member 36 serves as an acoustic diaphragm as in a conventional loudspeaker. The sound output by the speaker 33 can then be transmitted through the support member 36.

Because the support member 36 is much larger than a an acoustic diaphragm of a conventional loudspeaker, the sound output by the loudspeaker 33 can be effectively transmitted to the conference attendees sitting around the teleconference device 10.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A teleconference device, comprising:
a microphone;
a support member; and
a loudspeaker comprising:
a hollow casing;
a speaker arranged within the hollow casing and on a bottom thereof; and
a hard plate arranged under the speaker and abutting against the support member;
wherein the hollow casing is heavier than the hard plate to cause the hard plate to stay in tight contact with the support member, to allow sound outputted by the loudspeaker through the support member.

2. The teleconference device according to claim 1, wherein the hollow casing is made of metal.

3. The teleconference device according to claim 1, wherein the hard plate is made of plastic.

4. The teleconference device according to claim 1, wherein the hollow casing defines a through hole to accommodate the hard plate.

5. The teleconference device according to claim 1, wherein the hard plate is flush with the bottom of the casing.

6. The teleconference device according to claim 1, wherein the support member is a thin film.
